(19) United States
(12) Patent Application Publication
(10) Pub. No.: US 2026/0035541 A1
(43) Pub. Date: Feb. 5, 2026

(54) COMPOSITION FOR A VEHICLE WHEEL MEMBER, AND A MOLDED BODY AND WHEEL BALANCE WEIGHT USING THE SAME

(71) Applicants: HYUNDAI MOTOR COMPANY, Seoul (KR); KIA CORPORATION, Seoul (KR); Flexon Inc., Gwacheon-si (KR)

(72) Inventors: Ho Dong Kim, Hwaseong-si (KR); Kang Sun Lee, Hwaseong-si (KR); Hyung Seok Kim, Hwaseong-si (KR)

(73) Assignees: HYUNDAI MOTOR COMPANY, Seoul (KR); KIA CORPORATION, Seoul (KR); Flexon Inc., Gwacheon-si (KR)

(21) Appl. No.: 18/955,356

(22) Filed: Nov. 21, 2024

(30) Foreign Application Priority Data
Jul. 31, 2024 (KR) 10-2024-0101344

(51) Int. Cl. C08K 3/08; B60B 15/28; C08K 3/22

(52) U.S. Cl. CPC C08K 3/08; B60B 15/28; B60B 2360/102; B60B 2360/324; B60B 2360/36; C08K 2003/2265; C08K 2201/005

(57) ABSTRACT

A composition for a vehicle wheel member and an article using the same are provided. The composition includes 100 parts by weight of thermoplastic polyurethane, 1 to 30 parts by weight of a plasticizer, and 400 to 1,680 parts by weight of metal particles. The composition has a density of 3 g/cm³ or more. The thermoplastic polyurethane has a Shore A hardness of 59 to 92.

### CROSS-REFERENCE TO RELATED APPLICATION

This application claims, under 35 U.S.C. § 119(a), the benefit of and priority to Korean Patent Application No. 10-2024-0101344, filed on Jul. 31, 2024, the entire contents of which are incorporated herein by reference.

### BACKGROUND

### (a) Technical Field

The present disclosure relates to a composition for a vehicle wheel member, and a molded body and a wheel balance weight using the same.

### (b) Background Art

Wheel balance weights may be provided to correct weight imbalances in the wheels, rims, and the like of vehicles. These wheel balance weights may usually include steel, but corrosion may occur under environmental conditions to which the wheel is exposed, high-temperature water inflow conditions, calcium chloride inflow conditions in winter, and the like. Moreover, peeling and lifting may occur due to poor adhesion to the curved surface of the wheel. Also, difficult precise control may result in excessive wheel balancing defects. Furthermore, such wheel balance weights may be prone to breakage during the manufacturing process due to insufficient fatigue resistance under repeated bending conditions.

Wheel balance weights to which a composition mainly including polyester resin is applied are problematic because fatigue performance is insufficient due to repeated bending and also because cracking or breakage frequently occurs during production and application of the molded body, deteriorating productivity.

The statements in this Background section merely provide background information related to the present disclosure and may not constitute prior art.

### SUMMARY

The present disclosure has been made in an effort to solve the problems encountered in the related art. An object of the present disclosure is to provide a composition and a molded body having excellent adhesion to the curved surface of a vehicle wheel and easy moldability.

Another object of the present disclosure is to provide a composition having fatigue resistance against repeated bending that may occur during manufacture of a product or balancing operation and capable of exhibiting excellent durability and a low wheel balancing error rate.

The objects of the present disclosure are not limited to the foregoing. The objects of the present disclosure should be more clearly understood through the following description and be realized by the means described in the claims and combinations thereof.

An aspect of the present disclosure provides a composition for a vehicle wheel member including 100 parts by weight of thermoplastic polyurethane, 1 to 30 parts by weight of a plasticizer, and 400 to 1,680 parts by weight of metal particles, in which the composition may have a density equal to or greater than 3 g/cm³, and the thermoplastic polyurethane may have a Shore A hardness in a range of 59 to 92.

Another aspect of the present disclosure provides a molded body including thermoplastic polyurethane, metal particles in an amount range of 400 to 1,680 parts by weight based on 100 parts by weight of the thermoplastic polyurethane, and a plasticizer, in which the molded body may have a density equal to or greater than 3.2 g/cm³, and the thermoplastic polyurethane may have a Shore A hardness in a range of 59 to 92.

### BRIEF DESCRIPTION OF THE DRAWINGS

The above and other features of the present disclosure are described in detail referring to embodiments thereof illustrated in the accompanying drawings, which are given hereinbelow by way of illustration only, and thus are not limitative of the present disclosure, and wherein:

FIG. 1 is a photograph of a wheel balance weight to which a molded body according to an embodiment of the present disclosure is applied and a film is attached;

FIG. 2 is photographs schematically showing a bending fatigue resistance test process described in Test Example;

FIG. 3 is photographs showing results after the bending fatigue resistance test of some examples described in Test Example; and

FIG. 4 is a photograph showing results after a hydrolysis resistance test of Reference Example 6 described in Test Example.

### DETAILED DESCRIPTION

The above and other objects, features and advantages of the present disclosure should be more clearly understood from the following embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those having ordinary skill in the art.

Throughout the drawings, the same reference numerals refer to the same or like elements. For the sake of clarity of the present disclosure, the dimensions of structures are depicted as being larger than the actual sizes thereof. It should be understood that, although terms such as “first”, “second”, and the like may be used herein to describe various elements, these elements are not to be limited by these terms. These terms are only used to distinguish one element from another element.

For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, and the like, when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

### Composition for Vehicle Wheel Member

An aspect of the present disclosure relates to a composition for a vehicle wheel member. The composition for the vehicle wheel member includes:
100 parts by weight of thermoplastic polyurethane,
1 to 30 parts by weight of a plasticizer; and
400 to 1,680 parts by weight of metal particles.

The composition may have a density of 3 g/cm³ or more, and the thermoplastic polyurethane may have a Shore A hardness of 59 to 92.

The vehicle wheel member may be a wheel balance weight, may be a member applied to adjust the wheel balance of a vehicle, may be a member that may be attached to a part such as a wheel, a rim of the wheel, and the like, and may be attached to a curved portion.

Moreover, the composition may be applied to wheel members of other transport means in addition to the vehicle wheel member, and may be applied as a composition for members or parts that require similar properties such as bending fatigue resistance, weather resistance, corrosion resistance, adhesion, and the like in addition to the wheel member.

The thermoplastic polyurethane (TPU) may be a thermoplastic plastic elastomer having predetermined elasticity. The thermoplastic plastic elastomer may be obtained by reacting A-1) at least one of polyester polyol, polyether polyol, or combinations thereof, A-2) a diisocyanate-based compound, A-3) a compound containing hydrogen and an acid functional group capable of reacting with isocyanate, A-4) a siloxane-based compound containing a hydroxyl group, A-5) a silane coupling agent, and A-6) a crosslinking agent.

For example, the thermoplastic polyurethane elastomer may be prepared by reacting, in the presence of 0.01 to 1 parts by weight of a catalyst, a composition for producing TPU including:
A-1) 100 parts by weight of at least one polyol of polyester polyol, polyether polyol, or combinations thereof,
A-2) 20 to 50 parts by weight of a diisocyanate-based compound,
A-3) 2 to 15 parts by weight of a compound containing hydrogen and an acid functional group capable of reacting with isocyanate,
A-4) 1 to 10 parts by weight of a siloxane-based compound containing a hydroxyl group,
A-5) 0.3 to 5 parts by weight of a silane coupling agent, and
A-6) 2 to 20 parts by weight of a crosslinking agent.

The number average molecular weight of A-1) the polyol may be 2,500 g/mol to 4,000 g/mol.

In A-1) the polyol, polyether polyol may be obtained by reacting an alkylene oxide such as ethylene oxide, propylene oxide, and the like with a polyhydroxy alkane or an amine compound. Examples of the hydroxy alkane may include glycols such as ethylene glycol, propylene glycol, and the like, and triols such as glycerol, trimethylolpropane, and the like. Examples of the amine compound may include ammonia, triethanolamine, ethylenediamine, and the like.

In A-1) the polyol, polyester polyol may be obtained by reacting a dicarboxylic acid with at least one diol. Examples of the dicarboxylic acid may include aliphatic dibasic acids such as adipic acid, glutaric acid, azelaic acid, and sebacic acid, and aromatic acids such as phthalic acid, isophthalic acid, terephthalic acid, and naphthenic acid. Examples of the diol may include glycols such as ethylene glycol, 1,2-propylene glycol, diethylene glycol, 1,4-butylene glycol, 1,6-hexylene glycol, and the like, and polyhydric alcohols such as glycerol, trimethylolpropane, pentaerythritol, and the like.

Examples of A-2) the diisocyanate-based compound may include toluene diisocyanate (TDI), 4,4′-diphenylmethane diisocyanate (MDI), xylene diisocyanate, hydrogenated diphenylmethane diisocyanate, naphthalene-1,5-diisocyanate (NDI), isophorone diisocyanate (IPDI), cyclohexyl diisocyanate (CHDI), hexamethylene diisocyanate, and the like.

Examples of A-3) the compound containing hydrogen and an acid functional group capable of reacting with isocyanate may include N,N-bis(2-hydroxyethyl)-2-aminoethanesulfonic acid, 2,2-bis(hydroxymethyl)butyric acid, 2,2-bis(hydroxymethyl)pentanoic acid, 2,2-bis(hydroxymethyl)hexanoic acid, 3,5-diamino-4-methylbenzoic acid, 4,4-diamino(1,1-diphenyl)-2,2-disulfonic acid, 4,6-diaminobenzene-1,3-disulfonic acid, 4,4-diamino-2,2-stilbenzenedisulfonic acid, dihydrolipoic acid, and the like.

Also, A-3) the compound containing hydrogen and an acid functional group capable of reacting with isocyanate may include a compound neutralized with a neutralizing agent, and an amine compound may be used as the neutralizing agent. Examples of the amine compound may include butylamine, 3-amino-1,2,4-triazole, (2-methylbutyl)amine, 5-cyclopropyl-1,3,4-oxadiazol-2-amine, dodecylamine, cyclohexylamine, and the like.

A-4) The siloxane-based compound containing a hydroxyl group may be a hydroxyl group-containing polydimethylsiloxane (PDMS) and may have a hydroxyl value of 20 mgKOH/g to 100 mgKOH/g.

A-5) The silane coupling agent may be a silane coupling agent containing at least one of an amino group, a mercapto group, or an epoxy group, and examples thereof may include γ-aminopropyl trimethoxy silane, 3-mercaptopropyl trimethoxysilane, γ-glycidoxy propyl trimethoxy silane, 3-methacryloxypropyl trimethoxy silane, and the like. The silane coupling agent may inhibit surface migration of the siloxane-based compound.

Examples of A-6) the crosslinking agent may include diethanolamine, 1,4-butylenediamine, 1,6-hexamethylenediamine, triethanolamine, diisopropanolamine, ethylene glycol, butanediol, 1,6-hexanediol, 1,4-cyclohexanediol, low-molecular-weight alkylene oxides, adducts of polyfunctional amines or alcohols, and various low-molecular-weight polyfunctional hydroxy or amine compounds. The low molecular weight may mean a weight average molecular weight of 50 to 500.

The weight average molecular weight of A) the thermoplastic polyurethane may be 80,000 g/mol to 200,000 g/mol.

When A) the thermoplastic polyurethane contains a polyether-based polyol as the main component, affinity with metal particles and weather resistance may be further improved. When A) the thermoplastic polyurethane contains a polyester-based polyol as the main component, better repeated bending fatigue resistance may be exhibited, but it may be necessary to further include a hydrolysis inhibitor as described below.

The thermoplastic polyurethane may have a Shore A hardness of 59 to 92, for example 60 to 90. If the Shore A hardness is less than 59, the molded body to which the composition is applied may be broken under tension conditions due to insufficient mechanical properties, and the shape may be difficult to maintain during extrusion molding of the composition, resulting in a decrease in productivity. On the other hand, if the Shore A hardness exceeds 92, repeated bending fatigue resistance may decrease due to insufficient elasticity and flexibility of the material, excess plasticizer may be required due to difficult mixing, and separation of metal particles in the molded body to which the composition is applied may occur.

Examples of the commercially available product of A) the thermoplastic polyurethane may include trade names Desmopan 9370A (Covestro), Elastollan 1180A 10 (BASF), Estane 58245 (Lubrizol), and the like.

B) The plasticizer may be a liquid or solid material capable of increasing flexibility and processability of the composition. The plasticizer may be present in a liquid phase at room temperature of 23° C. to 25° C.

B) The plasticizer may include at least one of paraffinic compounds, naphthenic compounds, olefinic compounds, aromatic compounds, or combinations thereof, and may include, for example, a naphthenic compound (oil) or an olefinic compound (oil).

The composition for a vehicle wheel member may include B) the plasticizer in an amount of 1 to 30 parts by weight, for example 7 to 28 parts by weight, based on 100 parts by weight of A) the thermoplastic polyurethane. If the amount of the plasticizer is less than 1 part by weight, the surface shape may become poor due to insufficient flexibility, interfacial reactivity between the metal particles and the polymer component may be insufficient, and cracking may easily occur due to repeated bending. On the other hand, if the amount of the plasticizer exceeds 30 parts by weight, migration of the plasticizer to the polymer surface may occur primarily, stickiness may occur during blending, and the shape may become poor during extrusion molding.

Examples of the commercially available product of B) the plasticizer may include trade names such as Shellflex371 (Shell), Synfluid 6cSt (Chevron), and the like.

C) The metal particles may include a metal having corrosion resistance and high density and specific gravity, and examples thereof may include stainless steel, titanium, nickel, chromium, zinc, copper, nickel-copper alloy (Monel), nickel-chromium alloy (Inconel), nickel-molybdenum-chromium alloy (Hastelloy), and the like. In some embodiments, at least one of austenitic stainless steel, ferritic stainless steel, martensitic stainless steel, or combinations thereof is included.

In C) the metal particles, SUS304 may be used as austenitic stainless steel, and SUS309, 310, 314, 330, 303, 316, 317, and the like, may be used as necessary.

In C) the metal particles, SUS430 may be used as ferritic stainless steel, and SUS444, 434, 436, 405, 409, and the like may be used as necessary.

In C) the metal particles, SUS630 may be used as martensitic stainless steel,

and SUS631, and the like may be used as necessary.

C) The metal particles may be a mixture of first particles having a relatively small particle size, second particles having a medium size, and third particles having a relatively large size. The size (D50) of the first particles may be from 10 μm to 50 um, the size (D50) of the second particles may be from 30 μm to 120 μm, and the size (D50) of the third particles may be from 120 μm to 150 μm. Herein, D50 may be a particle size at which the cumulative weight corresponds to 50% in a particle size-weight distribution.

C) The metal particles may include the first particles and the second particles. The weight ratio of the first particles to the second particles may be 3:7 to 7:3.

When C) the metal particles include the first particles, the second particles, and the third particles, 50 to 150 parts by weight of the first particles and 50 to 150 parts by weight of the third particles may be mixed based on 100 parts by weight of the second particles.

The size (D50) of C) the metal particles may be 1 μm to 150 μm, for example 30 μm to 120 μm. When the particle size thereof falls in the above range, high dispersibility may be ensured, these particles may be loaded in the thermoplastic polyurethane at a high filling rate, and desired mechanical properties may be obtained.

The density of C) the metal particles may be 6 g/cm³ or more, for example 6.5 g/cm³ or more, and 10 g/cm³ or less. The density may correspond to a tap density and may be measured by minimizing the void ratio using a typical tap density meter. The apparent density of the metal particles may be 4 g/cm³ to 8 g/cm³.

C) The metal particles may have an irregular shape, a plate shape, a spherical shape, and the like. In some embodiments, the metal particles may have a spherical shape.

The composition for a vehicle wheel member may include C) the metal particles in an amount of 400 to 1,680 parts by weight, for example 600 to 1,650 parts by weight, based on 100 parts by weight of the thermoplastic polyurethane. If the amount of the metal particles is less than 400 parts by weight, the molded body to which the composition is applied may require a larger volume, and noise may be generated when applied to a vehicle wheel. On the other hand, if the amount of the metal particles exceeds 1,680 parts by weight, poor mixing may occur during composition mixing and production of a molded body, separation of the metal particles may occur, and interfacial reactivity between the metal particles and the thermoplastic polyurethane may be insufficient, resulting in a decrease in repeated bending fatigue resistance.

The composition for a vehicle wheel member may optionally include a hydrolysis inhibitor or an oxidation inhibitor, as needed. Examples of the hydrolysis inhibitor or antioxidant may include hydroxycitric structure-containing additives (trade names Stabaxol I, P200, and the like), carbamate bond-containing additives (trade names Stabaxol P100, Ucarlink XL-29SE, and the like), epoxide group-containing additives (oxazolidine, trade name Loxiol G59, and the like), phenol group-containing additives (trade names Irganox1010, 1076, 245, and the like), phosphate ester group-containing additives (trade names Irgafox168, Ultranox626, and the like), hydroxylamine group-containing additives (trade names Tinuvin 770, 765, and the like), carbodiimide-based compounds, and the like. The hydrolysis inhibitor may be added in an amount of 0.5 parts by weight to 5 parts by weight based on 100 parts by weight of the thermoplastic polyurethane. When the amount thereof falls in the above weight range, the hydrolysis inhibitor may be easily dispersed, and function thereof may be effectively applied.

The composition for a vehicle wheel member may further include an acid acceptor, a vulcanization accelerator, a processing aid, an anti-aging agent, a filler, and the like. The acid acceptor may include a metal oxide, a metal hydroxide, and the like. The vulcanization accelerator may include a quaternary ammonium salt, a quaternary phosphonium salt, and the like. The anti-aging agent may include a diphenyl amine derivative, a phenylenediamine derivative, and the like. The processing aid may include stearic acid, zinc oxide, and the like. The filler may include carbon black, kaolin clay, talc, diatomaceous earth, and the like.

The apparent density of the composition for a vehicle wheel member may be 3 g/cm³ to 8.5 g/cm³.

The composition for a vehicle wheel member may be produced into a molded body through extrusion molding, and the molded body may have good values for parameters related to bending fatigue resistance, hydrolysis resistance, salt water resistance (corrosion resistance), and weather resistance described below.

### Molded Body

Another aspect of the present disclosure relates to a molded body obtained by subjecting the composition for a vehicle wheel member to extrusion molding. The molded body may have a weight ratio of components substantially

similar to that of the composition for a vehicle wheel member described above, and some of the plasticizer component may be vaporized due to extrusion molding in the composition for a vehicle wheel member. For example, the molded body may include A) 100 parts by weight of thermoplastic polyurethane, B) 0.5 to 28 parts by weight of a plasticizer, and C) 400 to 1,680 parts by weight of metal particles, and may have a density of 3.2 g/cm³ to 8 g/cm³. The density may correspond to an apparent density.

The extrusion molding may include heating the composition for a vehicle wheel member to a predetermined temperature, extruding the heated result, and post-processing the extruded result.

In the extrusion molding, the heating temperature may be a temperature between the glass transition temperature and the melting point of the thermoplastic polyurethane, or a temperature range around the melting point, for example a temperature of 130° C. to 180° C.

In the extrusion molding, extrusion may proceed so as to form an extrudate having a desired shape.

In the extrusion molding, post-processing may include cutting the extrudate, printing the surface, and the like.

The extrusion molding may be performed using an extruder including a hopper into which raw materials are introduced, a barrel configured to communicate with the hopper and to include a flow space for the raw materials, a stirrer configured to stir and move the raw materials in the flow space, a heater configured to heat the flow space, and a discharge die configured to communicate with the flow space.

Also, a Banbury mixer, a kneader, a mixing roller, and the like may be used to mix, blend, and disperse the composition for a vehicle wheel member before extrusion molding.

The molded body may not substantially crack or break when subjected to the following bending test 50 times. Herein, a crack may be a gap or split portion having a width of 50 μm or more.

### [Bending Test]

A test of bending a plate-shaped molded body having a width of 23 mm, a length of 100 mm, and a thickness of 4.5 mm for 2 seconds so that one end and the remaining end in a longitudinal direction are in contact with each other followed by restoration to the original state thereof. The longitudinal direction means the longer direction of the horizontal or vertical directions of the molded body.

The molded body may not substantially crack or break even when the bending test is performed 70 or 100 times.

The molded body may not crack or break after treatment at a temperature of 120° C. and a relative humidity of 100% for 48 hours according to MS 220-17 (4.6). The molded body may have a surface corrosion area of 0.1 vol % or less after

spray with salt water at a temperature of 35° C., a salt water concentration of 5 wt %, and a pH of 7 for 720 hours according to MS 600-35 (7.11) and IEC 60068-2-52, and may not corrode substantially. The salt water may include sodium chloride or calcium chloride at the concentration described above.

The molded body may not substantially cause discoloration, migration, and whitening even after repeating one cycle including irradiation with 340 nm ultraviolet light at 0.75 W/m² for 120 minutes and then spray with water in the dark for 60 minutes until the ultraviolet irradiance reaches 2,500 KJ/m² according to MS 210-06, SAE J2527, and ASTM D7869, and changes in L, a, and b values of CIE Lab chromaticity coordinates measured after ultraviolet irradiation under the conditions described above may be within +5% based on the values before irradiation.

The molded body may be applied to parts or members that require the properties described above, may be applied as a wheel member of a vehicle, and may be applied as a wheel balance weight. When applied as a wheel balance weight, the molded body may be formed in a rollable long band shape as shown in

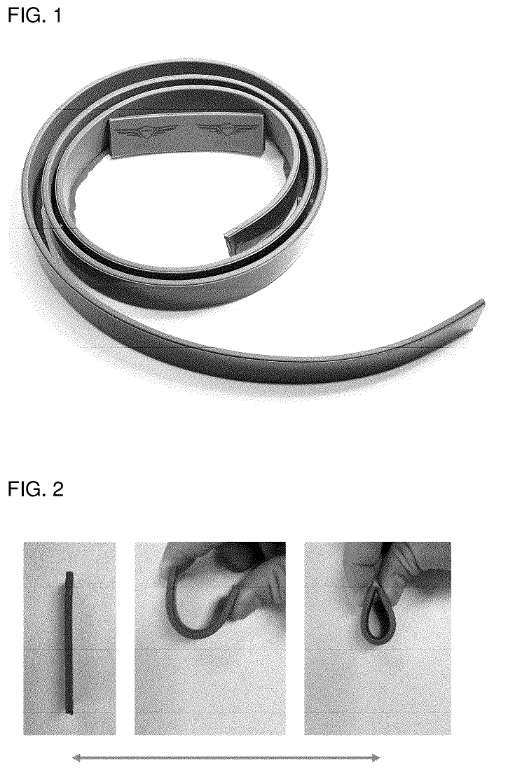

FIG. 1. Also, a separate film may be further attached to one side and/or the remaining side of the molded body, and an adhesive film and a release film may be attached thereto.

A better understanding of the present disclosure may be obtained through the following examples and comparative examples. However, these examples are not to be construed as limiting the technical spirit of the present disclosure.

### Example 1

A composition including A) 100 parts by weight of a polyether polyol-based thermoplastic polyurethane elastomer having a Shore A hardness of 60, B) 15 parts by weight of a naphthenic oil as a plasticizer, and C) 1,415 parts by weight of a ferritic stainless steel powder (30-120 μm) as metal particles, was mixed through a heating mixer and extruded through a heating extruder to produce a molded body. The mixing and extrusion were carried out at a temperature of 130-180° C.

### Example 2

A molded body was produced in the same manner as in Example 1, with the exception that A) the thermoplastic polyurethane elastomer having a Shore A hardness of 70 was used, B) the plasticizer was used in an amount of 19 parts by weight, and C) the metal particles were used in an amount of 1,650 parts by weight.

### Example 3

A molded body was produced in the same manner as in Example 1, with the exception that A) the thermoplastic polyurethane elastomer having a Shore A hardness of 80 was used, B) the plasticizer was used in an amount of 25 parts by weight, and C) the metal particles were used in an amount of 1,100 parts by weight.

### Example 4

A molded body was produced in the same manner as in Example 1, with the exception that A) the thermoplastic polyurethane elastomer having a Shore A hardness of 90 was used, B) the plasticizer was used in an amount of 28 parts by weight, and C) the metal particles were used in an amount of 900 parts by weight.

### Example 5

A molded body was produced in the same manner as in Example 1, with the exception that A) the thermoplastic polyurethane elastomer having a Shore A hardness of 70 was used, B) the plasticizer was used in an amount of 7 parts by weight, and C) the metal particles were used in an amount of 600 parts by weight.

### Example 6

A molded body was produced in the same manner as in Example 1, with the exception that A) a thermoplastic polyurethane elastomer having a Shore A hardness of 70 in which a polyether polyol-based polyurethane elastomer and a polyester polyol-based polyurethane elastomer were mixed in a weight ratio of 5:5 was used, C) the metal particles were used in an amount of 1,500 parts by weight, and 1 part by weight of a hydrolysis inhibitor was further used.

### Comparative Example 1

A molded body was produced in the same manner as in Example 1, with the exception that A) the thermoplastic polyurethane elastomer having a Shore A hardness of 58 was used, B) the plasticizer was used in an amount of 13 parts by weight, and C) the metal particles were used in an amount of 1,380 parts by weight.

### Comparative Example 2

A molded body was produced in the same manner as in Example 1, with the exception that A) the thermoplastic polyurethane elastomer having a Shore A hardness of 93 was used, B) the plasticizer was used in an amount of 35 parts by weight, and C) the metal particles were used in an amount of 850 parts by weight.

### Comparative Example 3

A molded body was produced in the same manner as in Example 1, with the exception that A) the thermoplastic polyurethane elastomer having a Shore A hardness of 70 was used, B) the plasticizer was used in an amount of 28 parts by weight, and C) the metal particles were used in an amount of 1,700 parts by weight.

### Comparative Example 4

A molded body was produced in the same manner as in Example 1, with the exception that A) the thermoplastic polyurethane elastomer having a Shore A hardness of 70 was used, B) the plasticizer was omitted, and C) the metal particles were used in an amount of 1,300 parts by weight.

### Comparative Example 5

A molded body was produced in the same manner as in Example 1, with the exception that A) the thermoplastic polyurethane elastomer having a Shore A hardness of 70 was used, B) the plasticizer was omitted, and C) the metal particles were used in an amount of 380 parts by weight.

### Reference Example 6

A molded body was produced in the same manner as in Example 1, with the exception that A) a polyester polyol-based thermoplastic polyurethane elastomer having a Shore A hardness of 70 was used, B) the plasticizer was used in an amount of 7 parts by weight, and C) the metal particles were used in an amount of 600 parts by weight. A separate hydrolysis inhibitor was not added to the raw materials.

### Comparative Example 7

A molded body was produced in the same manner as in Example 1, with the exception that A) the thermoplastic polyurethane elastomer having a Shore A hardness of 70 was used, B) the plasticizer was used in an amount of 35 parts by weight, and C) the metal particles were used in an amount of 1,700 parts by weight.

The conditions of Examples, Comparative Examples, and Reference Example are briefly shown in Table 1 below.

TABLE 1

| | | | | C) Metal |
|---|---|---|---|---|
| | | A) TPU | B) Plasticizer | particles |
| | | Shore A | parts by | parts by |
| Classification | A) TPU | hardness | weight | weight |
| Example 1 | Polyether-TPU | 60 | 15 | 1,415 |
| Example 2 | Polyether-TPU | 70 | 19 | 1,650 |
| Example 3 | Polyether-TPU | 80 | 25 | 1,100 |
| Example 4 | Polyether-TPU | 90 | 28 | 900 |
| Example 5 | Polyether-TPU | 70 | 7 | 600 |
| Example 6 | Polyether-TPU | 70 | 15 | 1,500 |
| | and polyester- | | | |
| | TPU | | | |
| Comparative | Polyether-TPU | 58 | 13 | 1,380 |
| Example 1 | | | | |
| Comparative | Polyether-TPU | 93 | 35 | 850 |
| Example 2 | | | | |
| Comparative | Polyether-TPU | 70 | 28 | 1,700 |
| Example 3 | | | | |
| Comparative | Polyether-TPU | 70 | 0 | 1,300 |
| Example 4 | | | | |
| Comparative | Polyether-TPU | 70 | 0 | 380 |
| Example 5 | | | | |
| Reference | Polyester-TPU | 70 | 16 | 1,650 |
| Example 6 | | | | |
| Comparative | Polyether-TPU | 70 | 35 | 1,700 |
| Example 7 | | | | |

TPU: Thermoplastic polyurethane elastomer

### Test Example—Measurement of Bending Fatigue Resistance and Density (Specific Gravity)

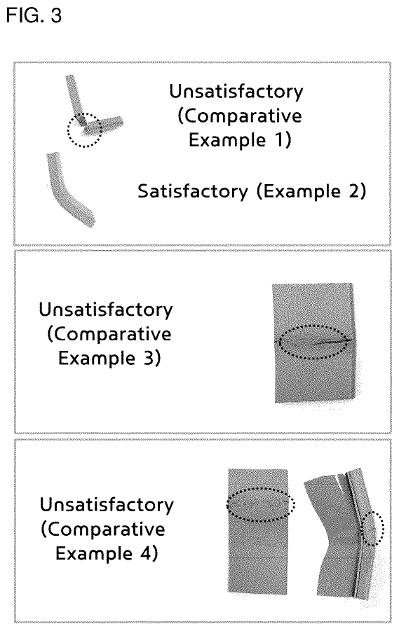

The bending fatigue resistance of the molded bodies produced in Examples, Comparative Examples, and Reference Example was measured by the following bending test, as shown in FIG. 2, and the apparent density (23° C.) thereof was measured using a density meter, and the results thereof are shown in Table 2 below and FIG. 3.

### [Bending Test]

A test of repeating one cycle including bending a plate-shaped molded body having a width of 23 mm, a length of 100 mm, and a thickness of 4.5 mm at a temperature of 23° C. and a relative humidity of 50% for 2 seconds so that one end and the remaining end in a longitudinal direction are in contact with each other followed by restoration to the original state thereof until cracking occurs.

### Test Example—Measurement of Hydrolysis Resistance

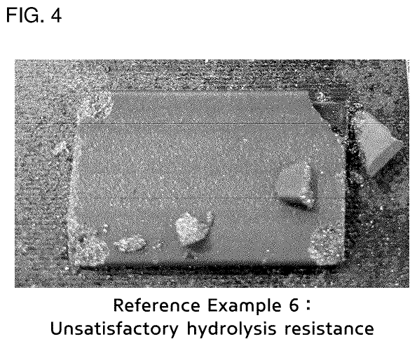

The molded bodies produced in Examples, Comparative Examples, and Reference Example were treated at a temperature of 120° C. and a relative humidity of 100% for 48 hours according to MS 220-17 (4.6), after which the presence or absence of cracking and breakage was measured. The results thereof are shown in Table 2 below, and some of the results are shown in FIG. 4.

### Test Example—Measurement of Salt Water Resistance

The surface corrosion state of the molded bodies produced in Examples, Comparative Examples, and Reference Example was measured by spraying salt water at a temperature of 35° C., a salt water concentration of 5 wt %, and a pH of 7 for 720 hours according to MS 600-35 (7.11) and IEC 60068-2-52, and the results thereof are shown in Table 2 below.

### Test Example—Measurement of Weather Resistance

The molded bodies produced in Examples, Comparative Examples, and Reference Example were treated by repeating one cycle including irradiation with 340 nm ultraviolet light at 0.75 W/m² for 120 minutes and then spray with water in the dark for 60 minutes until the ultraviolet irradiance reached 2,500 KJ/m² according to MS 210-06 and SAE J2527, after which discoloration, migration, and whitening thereof were measured, and the results thereof are shown in Table 2 below.

TABLE 2

| | | Apparent | | | | |
|---|---|---|---|---|---|---|
| | Bending | density | | | | |
| | fatigue | (specific | Hydrolysis | Salt water | Weather | |
| Classification | resistance | gravity) | resistance | resistance | resistance | Note |
| Example 1 | 50 times | 4.90 | Satisfactory | Satisfactory | Satisfactory | |
| | or more | | | | | |
| Example 2 | 50 times | 5.21 | Satisfactory | Satisfactory | Satisfactory | |
| | or more | | | | | |
| Example 3 | 50 times | 4.61 | Satisfactory | Satisfactory | Satisfactory | |
| | or more | | | | | |
| Example 4 | 50 times | 4.15 | Satisfactory | Satisfactory | Satisfactory | |
| | or more | | | | | |
| Example 5 | 50 times | 3.52 | Satisfactory | Satisfactory | Satisfactory | |
| | or more | | | | | |
| Example 6 | 50 times | 4.95 | Satisfactory | Satisfactory | Satisfactory | |
| | or more | | | | | |
| Comparative | 40 times | 4.70 | — | — | — | |
| Example 1 | | | | | | |
| Comparative | 50 times | 4.08 | — | — | Discoloration, | Poor |
| Example 2 | or more | | | | migration | extrusion |
| Comparative | 40 times | 4.85 | — | — | — | Poor |
| Example 3 | | | | | | mixing |
| Comparative | 45 times | 4.58 | — | — | — | |
| Example 4 | | | | | | |
| Comparative | 50 times | 2.88 | — | — | — | |
| Example 5 | or more | | | | | |
| Reference | 50 times | 5.07 | Cracking | — | Discoloration, | |
| Example 6 | or more | | | | migration | |
| Comparative | 50 times | 4.89 | Satisfactory | — | Discoloration, | Poor |
| Example 7 | or more | | | | migration | mixing |

Referring thereto, Examples 1 to 6 exhibited good composition mixing and molded body extrusion appearance and all of bending fatigue resistance, density, hydrolysis resistance, salt water resistance, and weather resistance satisfactory at appropriate levels.

In Comparative Example 1 using TPU having a slightly low Shore A hardness, cracking occurred when the bending test was repeated 40 times due to insufficient mechanical properties.

In Comparative Example 2 using TPU having a slightly high Shore A hardness, microcracking occurred at the edges during extrusion molding due to insufficient mixing and flexibility, and poor appearance resulted.

In Comparative Example 3 using excess metal particles, poor mixing and separation of the metal particles were caused. Also, cracking occurred when the bending test was repeated 40 times due to insufficient interfacial reactivity between the metal particles and the TPU.

In Comparative Example 4 not using the plasticizer, cracking occurred when the bending test was repeated 45 times due to insufficient interfacial reactivity between the metal particles and the TPU.

In Comparative Example 5, the density (specific gravity) of the molded body was unsatisfactory for wheel balance weight product conditions. If the density is 3 g/cm² or less, the larger relative volume for the specific weight required may cause noise in the wheel.

In Reference Example 6 using polyester polyol-based TPU but not using the hydrolysis inhibitor, cracking and crumbling occurred during measurement of hydrolysis resistance, and discoloration occurred due to surface blooming during evaluation of weather resistance.

In Comparative Example 7 using excess plasticizer, a sticky material was generated inside the mixer during mixing, and migration of the plasticizer occurred, causing discoloration during evaluation of weather resistance.

As is apparent from the foregoing, a composition according to an embodiment of the present disclosure can be easily molded, and a molded body to which the composition is applied can have excellent adhesion to the curved surface of a vehicle wheel.

In addition, the molded body to which the composition according to an embodiment of the present disclosure is applied has fatigue resistance against repeated bending that occurs during mass production or balancing operation, and is capable of alleviating the problem of reduced productivity.

In addition, the molded body to which the composition according to an embodiment of the present disclosure is applied is capable of reducing a work defect rate by 50% or more compared to metal products when applied to a wheel.

In addition, the molded body to which the composition according to an embodiment of the present disclosure is applied can be precisely balanced in small units of 0.5 g, thereby realizing a low wheel balancing error rate, and also, noise generation in a vehicle driving mode and interference with a brake caliper can be minimized.

In addition, the molded body to which the composition according to an embodiment of the present disclosure is applied can have excellent hydrolysis resistance under conditions such as hot summers, high temperature and high humidity, and the like, salt water resistance against sodium chloride, calcium chloride, and the like, and good weather resistance against ultraviolet light. Accordingly, the molded body can exhibit durability suitable for vehicle wheel members exposed to external environment for long periods of time.

The effects of the present disclosure are not limited to the foregoing. It should be understood that the effects of the present disclosure include all effects that can be inferred from the description of the present disclosure.

Although specific embodiments of the present disclosure have been described, those having ordinary skill in the art should appreciate that the present disclosure may be embodied in other specific forms without changing the technical spirit or essential features thereof. Thus, the embodiments described above should be understood to be non-limiting and illustrative in every way.

What is claimed is:

1. A composition for a vehicle wheel member, comprising:
100 parts by weight of thermoplastic polyurethane,
1 to 30 parts by weight of a plasticizer, and
400 to 1,680 parts by weight of metal particles,
wherein the composition has a density equal to or greater than 3 g/cm³, and the thermoplastic polyurethane has a Shore A hardness in a range of 59 to 92.

2. The composition of claim 1, wherein the vehicle wheel member is a wheel balance weight.

3. The composition of claim 1, comprising:
7 to 28 parts by weight of the plasticizer; and
600 to 1,650 parts by weight of the metal particles,
wherein the thermoplastic polyurethane has a Shore A hardness of 60 to 90.

4. The composition of claim 1, wherein:
the thermoplastic polyurethane comprises a thermoplastic polyurethane elastomer, and
the thermoplastic polyurethane elastomer is obtained by reacting at least one of polyester polyol, polyether polyol, or combinations thereof, a diisocyanate-based compound, a compound containing hydrogen and an acid functional group capable of reacting with isocyanate, a siloxane-based compound containing a hydroxyl group, a silane coupling agent, and a crosslinking agent.

5. The composition of claim 4, wherein, when the thermoplastic polyurethane elastomer comprises a polyester polyol-derived component, the composition further comprises a hydrolysis inhibitor.

6. The composition of claim 1, wherein a weight average molecular weight of the thermoplastic polyurethane is in a range of 80,000 to 200,000 g/mol.

7. The composition of claim 1, wherein the plasticizer comprises at least one of paraffinic compounds, naphthenic compounds, olefinic compounds, aromatic compounds, or combinations thereof.

8. The composition of claim 1, wherein the metal particles have a density equal to or greater than 6 g/cm³.

9. The composition of claim 1, wherein the metal particles comprise at least one of austenitic stainless steel, ferritic stainless steel, martensitic stainless steel, or combinations thereof.

10. The composition of claim 1, wherein a size (D50) of the metal particles is in a range of 1 μm to 150 μm.

11. The composition of claim 1, wherein:
the metal particles comprise first particles, second particles, and third particles,
a size (D50) of the first particles is in a range of 10 μm to 50 μm,
a size (D50) of the second particles is in a range of 30 μm to 120 μm, and
a size (D50) of the third particles is in a range of 120 μm to 150 μm.

12. The composition of claim 1, further comprising at least one of an acid acceptor, a vulcanization accelerator, a processing aid, an anti-aging agent, a filler, or combination thereof.

13. A molded body, comprising:
thermoplastic polyurethane,
metal particles in an amount range of 400 to 1,680 parts by weight based on 100 parts by weight of the thermoplastic polyurethane, and
a plasticizer,
wherein the molded body has a density equal to or greater than 3.2 g/cm³, and the thermoplastic polyurethane has a Shore A hardness in a range of 59 to 92.

14. The molded body of claim 13, wherein the molded body is not cracked or broken when a bending test is performed 50 times where in the bending test is
a test of bending a plate-shaped molded body having a width of 23 mm, a length of 100 mm, and a thickness of 4.5 mm at a temperature of 23° C. and a relative humidity of 50% for 2 seconds so that one end and a remaining end in a longitudinal direction are in contact with each other followed by restoration to an original state thereof.

15. The molded body of claim 13, wherein the molded body is not cracked or broken after treatment at a temperature of 120° C. and a relative humidity of 100% for 48 hours.

16. A wheel balance weight comprising the molded body of claim 13.
